(19) United States
(12) Patent Application Publication
(10) Pub. No.: US 2011/0049913 A1
(43) Pub. Date: Mar. 3, 2011

(54) FRONT PART FOR A MOTOR VEHICLE BODY

(75) Inventors: Volker BERNT, Trebur (DE); Theobald HOCK, Grossostheim (DE); Rolf EWERT, Russelsheim (DE)

(73) Assignee: GM GLOBAL TECHNOLOGY OPERATIONS, INC., Detroit, MI (US)

(21) Appl. No.: 12/845,328

(22) Filed: Jul. 28, 2010

(30) Foreign Application Priority Data
Jul. 28, 2009 (DE) 102009034906.5

(51) Int. Cl. B60R 19/02; B62D 35/00

(52) U.S. Cl. 293/102; 296/180.1

(57) ABSTRACT

A front part of a motor vehicle body is provided with a bumper and a lower bumper support supporting the bumper. A clearance that is open to the bottom is formed in the lower bumper support, from which a spoiler can be extended downwards.

### CROSS-REFERENCE TO RELATED APPLICATION

This application claims priority to German Patent Application No. 102009034906.5, filed Jul. 28, 2009, which is incorporated herein by reference in its entirety.

### TECHNICAL FIELD

The present invention relates to a front part of a motor vehicle body with a bumper and a bumper support supporting the bumper.

### BACKGROUND

In order to satisfy more recent legal requirements for pedestrian protection in the case of motor vehicle accidents, body front parts have been developed with an upper and a lower bumper support, wherein the upper bumper support generally comprises a sturdy metal cross member behind a slightly compressible outer layer which is able to absorb large amounts of energy during a major collision, whereas the lower bumper support and the compressible layer in front of the upper bumper support with respect to the requirements of pedestrian protection are optimized in order to yield even with low collision energy that is typical for a pedestrian accident.

From DE 103 24 514 A1 an extendable front spoiler for a motor vehicle body is known. The front spoiler can be displaced linearly from a retracted position, in which it jumps back behind a bumper, and an extended position in which it extends the bumper downwards. The position of the front spoiler is to be adjusted automatically as a function of the vehicle speed, wherein the spoiler at low speeds is retracted and at high speeds extended. Thus, especially in the low speed range, in which a suitable configuration of the body front part can actually bring about effective protection, the spoiler does not contribute to pedestrian protection. The same dilemma exists with the front spoiler known from DE 10 2004 013 754 A1.

From DE 30 03 568 A1, a body front part is known. A lower region of the bumper and a support supporting the bumper are extended at low speeds, so that in the event of a collision with a pedestrian they strike said pedestrian's legs first in order to let him fall on to the engine hood. Since the protruding lower bumper region is aerodynamically disadvantageous at higher speeds it is folded into a sunken position at higher speeds. To date no success has been had with combining the requirements of pedestrian protection with speed-adapted aerodynamics of the front part of a motor vehicle body.

### SUMMARY

Embodiments of the present invention solves this object through a front part of a motor vehicle body with a bumper and with a lower bumper support supporting the bumper, wherein in the lower bumper support a clearance open towards the bottom is formed, from which a spoiler can be extended downwards. In contrast with previous approaches, separation between the lower bumper and the spoiler is thus introduced which makes it possible to substantially optimize the lower bumper support for pedestrian protection and the spoiler for aerodynamics. In that the spoiler is kept refracted in the clearance at low speeds, it influences the aerodynamics of the body front part only a little or not at all, but simultaneously contributes to the stiffness of the lower bumper in the retracted state in that it fills out the clearance. This makes possible weight saving compared with a front part, wherein the lower bumper support and the spoiler are functionally entirely separated from each other and the necessary stiffness of the lower bumper support solely has to be provided by its wall thickness. Although the front part according to the invention is weakened at the height of the lower bumper support when the spoiler is extended from the clearance, any restriction of the pedestrian protection effect connected with this is insignificant however if extending of the spoiler takes place at high speeds at which known body front parts are no longer able to provide effective pedestrian protection anyway.

Preferentially, the spoiler is more resistant to deformation than a region of the bumper support extending between the spoiler and the bumper. This means that the energy absorbed per unit distance of the deformation is substantially less with the bumper support than with the spoiler. This can go so far as to substantially reduce the function of the bumper support to closing off the engine compartment towards the bottom, while the collision energy in the event of a collision is absorbed to quite a predominant part by the spoiler.

In order to achieve the necessary strength of the spoiler it is preferentially manufactured at least to a substantial part of a fiber-reinforced plastic, more preferably of polyamide.

The bumper support by contrast can consist of a relatively pliable, economical material that is comfortably processed such as polypropylene, which can also be used for the bumper proper.

Preferentially, the spoiler and the clearance each have front walls which in the retracted state of the spoiler are located opposite each other, so that when a front region of the lower bumper support gives way to the back in the event of a collision, the resulting pressure can be completely transferred on to the spoiler without driving it out of the clearance. Thus, the stiffness of the spoiler effectively contributes to the stiffness of the lower bumper support.

In order to discharge the pressure acting on the spoiler in lateral direction and introduce it in the carrying structure of the motor vehicle body the spoiler is preferentially reinforced through ribs oriented obliquely to the vehicle longitudinal direction.

Since the function of the front region of the bumper support, which extends between the bumper and the spoiler, substantially is the force transmission to the spoiler, this region is preferentially reinforced through ribs orientated in vehicle longitudinal direction.

Likewise under the aspect of force discharge the spoiler in top view practically follows an arched course with front side curved outward and lateral ends supported on a carrying structure of the body, more preferably an auxiliary frame. Practically, a corresponding arched configuration is also obtained for the clearance which accommodates the spoiler in the retracted state.

Preferentially the ends of the spoiler are hinged on the carrying structure in order to serve as hinges for the movement between the refracted and the extended state in addition to its function of force discharge.

As a further stiffening element the lower bumper support can comprise a substantially horizontal plate about which the clearance extends in an arch.

In order to effectively introduce forces into this horizontal plate in the event of a collision, said plate can be practically connected to a vertical rear wall of the clearance, opposite of which is located a vertical rear wall of the spoiler in the retracted state.

Furthermore, an actuator is practically provided in order to automatically place the spoiler in the retracted position at a low vehicle speed and in the extended position at a high vehicle speed.

### BRIEF DESCRIPTION OF THE DRAWINGS

The present invention will hereinafter be described in conjunction with the following drawing figures, wherein like numerals denote like elements, and:

FIG. 1 is a front view of a bumper for a motor vehicle body;

FIG. 2 is a partial view of the bumper from the inside and of a lower bumper support supporting it and a spoiler; and

FIG. 3 is a section along a longitudinal centre plane of the body through a lower region of the bumper, the lower bumper support and the spoiler.

### DETAILED DESCRIPTION

The following detailed description is merely exemplary in nature and is not intended to limit application and uses. Furthermore, there is no intention to be bound by any theory presented in the preceding background or summary or the following detailed description.

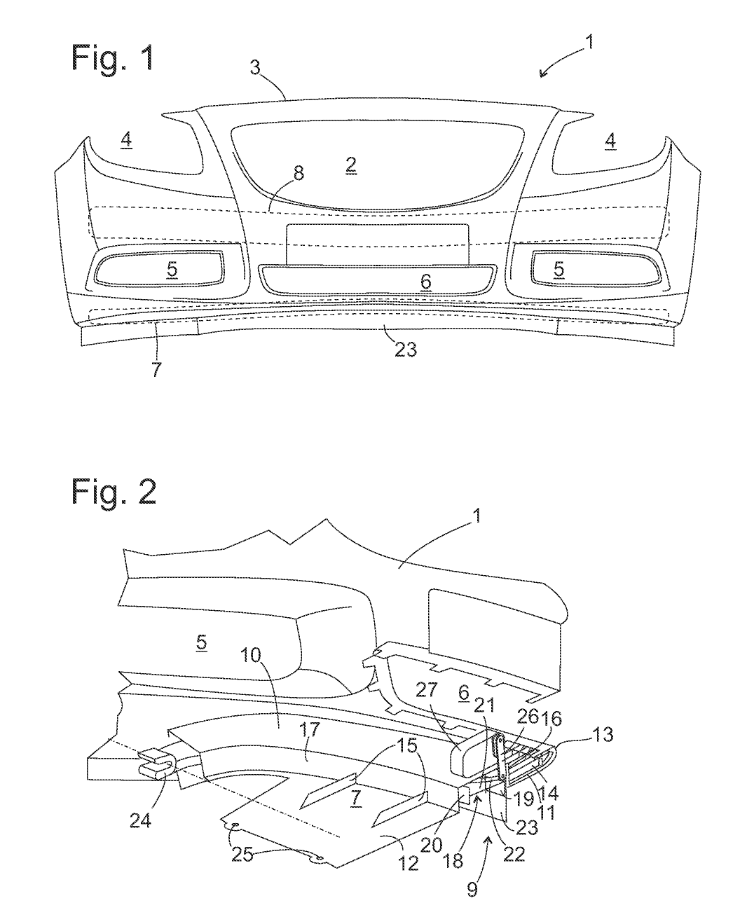

FIG. 1 shows a front view of a front bumper 1 of a motor vehicle body, preferentially deep-drawn of plastic. The bumper 1 is extended upwards to beyond a radiator grille opening 2 and its upper edge 3 immediately borders the front edge of an engine hood (not shown). The grille clearances 4 open at the edge on the left and right of the radiator grille opening 2 are provided in order to accommodate low-beam headlamps. Additional openings 5 below the clearances 4 are intended for other lamps such as fog lamps, indicators etc. Between the openings 5 and below the radiator grille opening 2 a further long-stretched inlet opening 6 for cooling and combustion air is located.

In its regions protruding farthest forward the bumper 1 is supported directly below the inlet opening 6 as well as between said inlet opening and the radiator grille opening 2 through a lower and upper bumper support which, since concealed behind the bumper 1, are drawn into FIG. 1 schematically as broken outlines 7 and 8 respectively. The upper bumper support 8 can be formed through a horizontal steel profile in a manner known per se, which is connected with the inner surface of the bumper 1 via a relatively pliable, compressible hard foam layer.

The lower bumper support 7 is an injection molded part of plastic, more preferably polypropylene, whose structure becomes clear by means of FIG. 2. Viewed from the vehicle interior, this figure shows a part of the bumper 1 as well as a left half each of the lower bumper support 7 and a front spoiler 9. The lower bumper support 7 is substantially shaped like a horizontal plate which is sub-divided into a front region 11 and a back region 12 through a clearance 10 extending in an arch and which is open towards the bottom. The front region 11 extends as far as to a groove open at the back formed on the inside of the bumper 1 below the inlet opening 6 in order to directly reinforce the bumper 1 on its point 13 protruding farthest to the front.

In order to set a stiffness of the body front part necessary for effective pedestrian protection, the plate-like regions 11, 12 of the bumper support 7 can be reinforced through ribs 14, 15 as required. FIG. 2 shows a large number of ribs 14 oriented in vehicle longitudinal direction in the front region 11 of the bumper support 7, whose object substantially is to prevent that the front region 11 under a collision immediately collapses locally and to introduce the force of the collision into the front spoiler 9, whose resistance to deformation is substantially greater than that of the bumper support 7. One or a plurality of ribs 14 in the front region 11 of the bumper support 7 running in vehicle transverse direction ensures that the longitudinal ribs do not yield sideways even under minor load thus allowing the region 11 to collapse.

The clearance 10 is rectangular in cross section, with vertical front and back walls 16, 17. The front spoiler 9 substantially shown sunk in the clearance 10 in FIG. 1 comprises a stiff highly loadable support profile 18 of glass fiber reinforced polyamide of substantially H-shaped cross section, with vertical ribs 19, 20 located a short distance opposite the walls 16, 17, of a horizontal base plate 21 extending between the ribs 19, 20 and stiffening ribs 21 extending over the base plate 21 if required. The stiffening ribs 22 extend on top and bottom of the base plate 21 predominantly at an angle of approximately 45° to the vehicle longitudinal direction, in order to discharge pressure transmitted to the front vertical rib 19 from the front region 11 of the bumper support 7 to the side and to the rear, towards the ends of the support profile 18. On the front vertical rib 19 of the support profile 18 an apron 23 is attached which in the shown retracted position of the front spoiler 9 also protrudes downwards from the clearance 10. In contrast with the support profile 18 the apron 23 is practically flexible in order to be able to yield when driving over an obstacle of low height that does not reach as far as the bumper 1. In contrast with the support profile 18 the apron can therefore consist of a relatively pliable material; like the bumper 1 and the lower bumper support 7 it can be more preferably manufactured from polypropylene.

The lateral ends of the support profile 18 are shaped like forks 24 which act on an auxiliary frame of the body which is not shown capable of being swiveled about a horizontal axis drawn-in as dash-dotted line, which auxiliary frame supports itself in a manner known per se among other things on the engine and parts of the transmission. The back edge of the lower bumper support 7 is also fastened to this auxiliary frame and is provided with holes 25 for this purpose. Alternatively, the ends of the support profile can also be supported on longitudinal members of the body.

When a collision with a pedestrian occurs while the front spoiler 9 is in the retracted position shown in FIG. 2 the front region 11 of the lower bumper support 7 is initially forced back so that the gap between the wall 16 and the rib 19 closes. Thus the support profile 18 is loaded and a part of the force of the collision is directly discharged to the auxiliary frame through the support profile 18. When the support profile 18 is deformed under the collision the gap between the rib 20 and the wall 17 closes and the back region 12 of the lower bumper support 7 is also loaded and likewise deformed. The support profile 18 is thus fully integrated in the structure of the bumper support 7 in the event of a collision.

In the refracted position, the support profile 18 is held by an eccentric arm 26 which extends through an opening on the top of the clearance 10 to an actuator motor 27 mounted on the top of the bumper support 7. The actuator motor 27 is coupled to a speedometer of the vehicle in order to lower the front spoiler 9 above a limit speed of a few tenths of km/h.

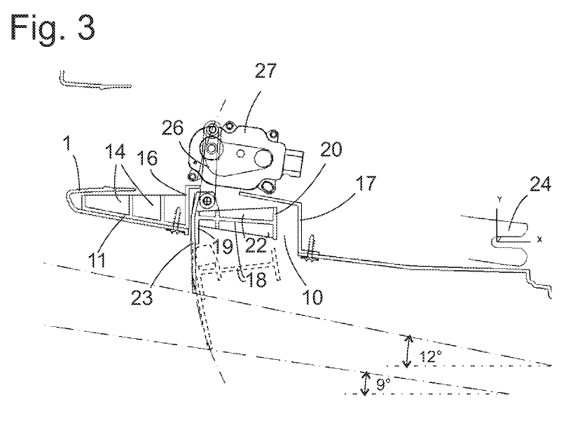

FIG. 3 shows the lower bumper support 7 in a longitudinal section, a part of the bumper 1 and the front spoiler 9, once with continuous lines in the refracted position and, with broken lines, in the extended position. In the extended position the support profile 18 is dislocated from the clearance 10 so that it no longer contributes to the stiffness of the lower bumper support 7. However, this contribution is not vital at high speeds since the collision energies far exceed the amounts of energy that can be dissipated by the lower bumper support 7 and the front spoiler 9.

The loading angle, i.e., the angle between the horizontal and a plane drawn into FIG. 3 as dash-dotted line which passes through the contact surfaces of the front wheels and touches a lowermost point of the vehicle body in front of the front wheels—in this case the lower edge of the apron 23—is reduced from approximately 12° in the retracted position to approximately 9°. In the extended position the apron 23 extends obliquely downwards and to the back, wherein the oblique position can even be reinforced relative to the representation of FIG. 3 when the apron 23 is bent under the pressure of the headwind. Thus the apron 23 together with the road below forms a nozzle in which the speed of the headwind is increased. The vacuum resulting through the Bernoulli Effect keeps the front part of the body pressed against the road and thus improves its road adhesion.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the summary and foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A front part of a motor vehicle body, comprising:
a bumper;
a lower bumper support supporting the bumper, wherein a clearance open to a bottom is formed in the lower bumper support from which a spoiler can be extended to the bottom.

2. The front part according to claim 1, wherein the spoiler has a greater resistant to deformation than a region of the lower bumper support extending between the spoiler and the bumper.

3. The front part according to claim 1, wherein the spoiler at least to a substantial part is at least partially manufactured of a fiber reinforced plastic.

4. The front part according to claim 1, wherein the spoiler at least to a substantial part is manufactured of a polyamide.

5. The front part according to claim 1, wherein the lower bumper support is at least partially manufactured of polypropylene.

6. The front part according to claim 1, wherein in a retracted state of the spoiler, a first vertical front wall of the spoiler is located opposite a second vertical front wall of the clearance.

7. The front part according to claim 1, wherein the spoiler comprises a base plate that is substantially horizontal in a refracted state.

8. The front part according to claim 1, wherein the spoiler is reinforced through a rib oriented obliquely to a vehicle longitudinal direction.

9. The front part according to claim 1, wherein a region of the lower bumper support extending between the spoiler and the bumper is reinforced through s rib oriented in a vehicle longitudinal direction.

10. The front part according to claim 1, wherein the spoiler is arch-shaped with a front curved to an outside.

11. The front part according to claim 10, wherein two lateral ends of the spoiler are adapted to act on a carrying structure, more preferably an auxiliary frame of a body.

12. The front part according to claim 11, wherein the carrying structure is the auxiliary frame of the body.

13. The front part according to claim 11, wherein ends of the spoiler are articulated on the carrying structure.

14. The front part according to claim 10, wherein the lower bumper support comprises a substantially horizontal plate about which the clearance extends in an arch.

15. The front part according to claim 14, wherein the substantially horizontal plate is connected with a vertical back wall of the clearance located opposite of which is a rear wall of the spoiler that is substantially vertical in a retracted state.

16. The front part according to claim 1, further comprising an actuator equipped to place the spoiler in a retracted state at a low vehicle speed and in an extended position at a high vehicle speed.
